(19) United States
(12) Patent Application Publication
(10) Pub. No.: US 2026/0318945 A1
(43) Pub. Date: Oct. 15, 2026

(54) ACCELEROMETER PROOF MASS ELEMENT

(71) Applicant: Honeywell International Inc., Charlotte, NC (US)

(72) Inventor: Paul W. Dwyer, Seattle, WA (US)

(21) Appl. No.: 19/176,021

(22) Filed: Apr. 10, 2025

(51) Int. Cl. G01P 15/135; G01P 15/125; G01P 15/13

(52) U.S. Cl. CPC G01P 15/135; G01P 15/125; G01P 15/131

(57) ABSTRACT

One or more examples including a proof mass element of an accelerometer, the proof mass element defining: a first surface; a second surface parallel with the first surface; and two or more recesses, wherein each recess of the two or more recesses extends from one of the first surface or the second surface towards the other of the first surface or the second surface; wherein the first surface is coupled to an electrically conductive element through a first bond within a first recess of the two or more recesses, wherein the second surface is coupled to the electrically conductive element within a second recess of the two or more recesses through a second bond, the second recess being different from the first recess, and wherein the first surface is electrically coupled to the second surface via the electrically conductive element.

### TECHNICAL FIELD

This disclosure relates to accelerometers.

### BACKGROUND

Accelerometers function by detecting a displacement of a proof mass under inertial forces. Some accelerometers include a capacitive pick-off system. For example, electrically conductive material (e.g., a capacitor plate) may be deposited on the upper surface of the proof mass, and similar electrically conductive material may be deposited on the lower surface of the proof mass. An acceleration or force applied along the sensitive axis of the accelerometer causes the proof mass to deflect either upwardly or downwardly causing the distance (e.g., a capacitive gap) between the pick-off capacitance plates and upper and lower non-moving members to vary. This variance in the capacitive gap causes a change in the capacitance of the capacitive elements, which is representative of the displacement of the proof mass along the sensitive axis. The change in the capacitance may be used as a displacement signal, which may be applied to a servo system that includes one or more electromagnets (e.g., a force-rebalancing coil) to return the proof mass to a null or at-rest position.

### SUMMARY

In general, the disclosure is directed to devices, systems, and techniques for manufacturing a proof mass element of an accelerometer (e.g., a force-balance accelerometer). The proof mass element may define parallel outer surfaces (e.g., a first surface and a second surface). The first surface may be electrically coupled to the second surface. Each of the outer surfaces may need to be coated with an electrically conductive metal, e.g., via a metallization technique. Rotation of proof mass element within a metallizing assembly may lead to variations in the thickness of the metallic material along the surfaces. The variation in the thickness of the metallic material may lead to increase strain on the proof mass element when the proof mass element undergoes changes in temperature. Rotation of proof mass element within the metallizing assembly may also be complex and costly, e.g., requiring masking of portions of the proof mass element and/or re-positioning of the proof mass element within the metallization assembly.

This disclosure is directed to an assembly to repeatably rotate a proof mass element within a metallization assembly. The assembly may include a fixture configured to retain the proof mass element. The proof mass element may be rotatable within the fixture, e.g., to expose different surfaces of the proof mass element to a nozzle within the metallization assembly without removing or re-positioning the fixture within the metallization assembly. A manufacturing assembly may orient the proof mass element in a first orientation within the fixture to metallize a first surface. The manufacturing assembly may then rotate the proof mass element within the fixture to a second orientation to metallize the second surface. The manufacturing assembly may electrically couple the metallized first surface to the metallized second surface via one or more wire bonds extending between recesses on the first surface and recesses on the second surface.

The devices, systems, and techniques may provide several advantages over other techniques for manufacturing proof mass elements for accelerometers. The use of the fixture to control the orientation of the proof mass element within the metallization assembly during the metallization process may reduce the variation in the thicknesses of the metallic material on the surfaces of the proof mass element, which may reduce strain on the proof mass element when the proof mass element undergoes changes in temperature. The use of the fixture may also simplify and/or eliminate the process of re-positioning the proof mass element within the metallization assembly to metallize both surfaces of the proof mass element, e.g., thereby simplifying the manufacturing process. The fixture may allow for accurate and repeatable orientation of the proof mass element within the metallization assembly, reducing a likelihood of error during the manufacturing process. The use of wire bonds to electrically couple the first surface to the second surface may reduce stress on specific portions of the proof mass element, e.g., thereby reducing bias and bias temperature coefficient in the accelerometer output.

In some examples, this disclosure describes a proof mass element of an accelerometer, the proof mass element defining: a first surface; a second surface parallel with the first surface; and two or more recesses, wherein each recess of the two or more recesses extends from one of the first surface or the second surface towards the other of the first surface or the second surface; wherein the first surface is coupled to an electrically conductive element through a first bond within a first recess of the two or more recesses, wherein the second surface is coupled to the electrically conductive element within a second recess of the two or more recesses through a second bond, the second recess being different from the first recess, and wherein the first surface is electrically coupled to the second surface via the electrically conductive element.

In some examples, this disclosure describes a proof mass element for an accelerometer, the proof mass element comprising: a first surface; a second surface parallel with the first surface; and two or more recesses, wherein each recess of the two or more recesses extends from one of the first surface or the second surface towards the other of the first surface or the second surface, wherein the first surface is electrically coupled to the second surface via a method comprising: affixing the proof mass element within a fixture in a first orientation; disposing an evaporant over the first surface of the proof mass element; rotating the proof mass element within the fixture from the first orientation to a second orientation, the second orientation being different to the first orientation; disposing the evaporant over the second surface of the proof mass element when the proof mass element is in the second orientation; forming a first bond between the first surface and an electrically conductive element within a first recess of the two or more recesses; and forming a second bond between the second surface and the electrically conductive element within a second recess of the two or more recesses, the second recess being different from the first recess.

In some examples, this disclosure describes a fixture for a proof mass element of an accelerometer, the fixture comprising: a fixed portion; and a movable portion defining an opening configured to retain the proof mass element, wherein the proof mass element defines: a first surface; a second surface parallel with the first surface; and two or more recesses, wherein each recess of the two or more recesses extends from one of the first surface or the second surface towards the other of the first surface or the second surface, wherein the fixture is configured to rotate the proof mass element via rotation of the movable portion relative to the fixed portion, and wherein when the proof mass element is retained within the opening, the fixture is configured to expose the first surface, the second surface, and the two or more recesses to allow for: disposition of an evaporant over the first surface and the second surface; and formation of a first bond between the first surface and an electrically conductive element within a first recess of the two or more recesses; and formation of a second bond between the second surface and the electrically conductive element within a second recess of the two or more recesses, the second recess being different from the first recess.

The summary is intended to provide an overview of the subject matter described in this disclosure. It is not intended to provide an exclusive or exhaustive explanation of the systems, device, and methods described in detail within the accompanying drawings and description below. Further details of one or more examples of this disclosure are set forth in the accompanying drawings and in the description below. Other features, objects, and advantages will be apparent from the description and drawings, and from the claims.

### BRIEF DESCRIPTION OF DRAWINGS

FIG. 1 is a block diagram illustrating an accelerometer system, in accordance with one or more techniques of this disclosure.

FIG. 2 is a conceptual diagram illustrating a side cutaway view of an example of the accelerometer system of FIG. 1.

FIG. 3 is a conceptual diagram illustrating an example proof mass element of the accelerometer system of FIGS. 1–2.

FIG. 4A is a conceptual diagram illustrating a first wire bond to a first surface of the proof mass element of FIG. 3.

FIG. 4B is a conceptual diagram illustrating a second wire bond to a second surface of the proof mass element of FIG. 3.

FIG. 5 is a conceptual diagram illustrating a fixture retaining the proof mass element of FIGS. 3–4B.

FIG. 6 is a flow chart illustrating an example technique for manufacturing the proof mass element of FIGS. 1–5.

Like reference characters denote like elements throughout the description and figures.

### DETAILED DESCRIPTION

This disclosure is directed to devices, systems, and techniques for manufacturing a proof mass element for an accelerometer system. For example, the accelerometer system may be an electromagnetic accelerometer system configured to precisely measure acceleration values. The electromagnetic accelerometer system uses a combination of electrical signals and magnetic signals to determine the acceleration of the object. For example, the accelerometer system may include a magnet, magnetic pole piece, an electrical coil, a non-moving member (e.g., forming a magnetic return path), and a proof mass. A magnetic flux may travel from the pole piece, through the coil to the non-moving member, and back to the proof mass. An electrical current may flow through the coil. The accelerometer system may generate a Lorentz force based on the magnetic flux and the electrical current, the Lorentz force representing a servo effect which prevents a displacement of the proof mass.

In some cases, the accelerometer system is configured to measure the acceleration of the object in real-time or near real-time, such that processing circuitry may analyze the acceleration of the object over a period of time to determine a positional displacement of the object during the period of time. For example, the accelerometer system may be a part of an inertial navigation system (INS) for tracking a position of an object based, at least in part, on an acceleration of the object. Additionally, the accelerometer system may be located on or within the object such that the accelerometer system accelerates with the object. As such, when the object accelerates, the acceleration system (including the proof mass element) accelerates with the object. Since acceleration over time is a derivative of velocity over time, and velocity over time is a derivative of position over time, processing circuitry may, in some cases, be configured to determine the position displacement of the object by performing a double integral of the acceleration of the object over the period of time. Determining a position of an object using the accelerometer system located on the object – and not using a navigation system external to the object (e.g., a global navigation satellite system (GNSS)) – may be referred to as “dead reckoning.”

The proof mass element may need to include a conductive coating (e.g., a metal coating) disposed over two or more outer surfaces of the proof mass element. A manufacturing assembly or operator may insert the proof mass element within a metallization assembly or device to metallize the outer surfaces of the proof mass element. This disclosure describes example fixtures configured to retain the proof mass element. The fixture may be inserted into the metallization assembly and may control the orientation of the proof mass element during the metallization process. The fixture may allow for controlled and repeatable re-orientation of the proof mass element within the metallization assembly, e.g., without removing the proof mass element and/or the fixture from the metallization assembly.

The controlled and repeatable re-orientation of the proof mass element may allow for reduced variation in the thickness of the metal coating over the surfaces of the proof mass element. The reduced variation in thickness may reduce strain on the proof mass element (e.g., at or around flexure(s) in the proof mass element) as the proof mass element undergoes changes in temperature, e.g., thereby reducing bias and bias temperature coefficient in the accelerometer system. The fixture may also simplify the manufacturing process, e.g., by simplifying and/or eliminating the process of repositioning the proof mass element within the metallization assembly between metallization of different surfaces. The fixture may also allow for more repeatable positioning of the proof mass element within the metallization assembly, e.g., thereby reducing error in the manufacturing process.

Different surfaces of the proof mass element may be electrically coupled by one or more wire bonds, e.g., in recesses on the proof mass element. The wire bond(s) may allow for the electrical coupling of opposing outer surfaces of the proof mass element, e.g., without increase stress or strain on portions of the proof mass element (e.g., at or around flexure(s) in the proof mass element), thereby reducing bias and bias temperature coefficient in the accelerometer system.

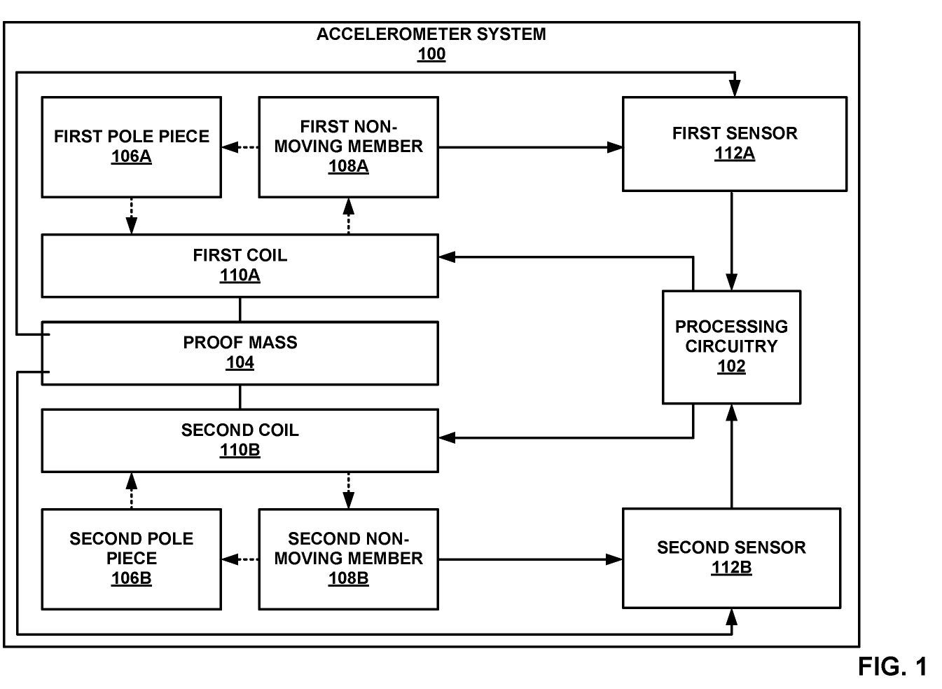

FIG. 1 is a block diagram illustrating an accelerometer system 100, in accordance with one or more techniques of this disclosure. As illustrated in FIG. 1, accelerometer system 100 includes processing circuitry 102, proof mass element 104 (alternatively referred to herein as “proof mass 104”), first pole piece 106A, second pole piece 106B (collectively, “pole pieces 106”), first non-moving member 108A, second non-moving member 108B (collectively, “non-moving members 108”), first coil 110A, second coil 110B (collectively, “coils 110”), first sensor 112A, and second sensor 112B (collectively, “sensors 112”).

FIG. 1 illustrates accelerometer system 100 as containing two separate magnetic loops. A first magnetic loop may be defined by first pole piece 106A, first non-moving member 108A, and first coil 110A. A second magnetic loop may be defined by second pole piece 106B, second non-moving member 108B, and second coil 110B. In other examples, accelerometer system 100 may only include one magnetic loop.

Accelerometer system 100 is configured to determine an acceleration associated with an object (not illustrated in FIG. 1) based on a magnitude of one or more electrical signals delivered to coils 110, the electrical signals preventing proof mass element 104 from displacing from a null position. For example, first sensor 112A may be configured to generate a first sense signal which indicates a size of a gap between proof mass element 104 and first non-moving member 108A and second sensor 112B may be configured to generate a second sense signal which indicates a size of a gap between proof mass element 104 and second non-moving member 108B. Processing circuitry 102 may generate a first electrical signal for delivery to first coil 110A based on the first sense signal and generate a second electrical signal for delivery to second coil 110B based on the second sense signal. The first electrical signal and the second electrical signal may induce one or more Lorentz forces which prevent the displacement of proof mass element 104 from a null position. For example, the first electrical signal may induce a first Lorentz force and the second electrical signal may induce a second Lorentz force, wherein the first Lorentz force and the second Lorentz force interact with proof mass element 104 to inhibit displacement of proof mass element 104 from the null position.

A Lorentz force represents a force caused by an interaction of an electric fields and a magnetic field. For example, a Lorentz force may be defined by a cross-product of an electrical field and a magnetic field, where the direction of the Lorentz force depends on the direction of the electrical field and the direction of the magnetic field, and where the magnitude of the Lorentz force depends on the magnitude of the electrical field and the magnitude of the magnetic field.

Processing circuitry 102 may include one or more processors that are configured to implement functionality and/or process instructions for execution within accelerometer system 100. For example, processing circuitry 102 may be capable of processing instructions stored in a memory. Processing circuitry 102 may include, for example, microprocessors, digital signal processors (DSPs), application specific integrated circuits (ASICs), field-programmable gate arrays (FPGAs), or equivalent discrete or integrated logic circuitry, or a combination of any of the foregoing devices or circuitry. Accordingly, processing circuitry 102 may include any suitable structure, whether in hardware, software, firmware, or any combination thereof, to perform the functions ascribed herein to processing circuitry 102.

A memory (not illustrated in FIG. 1) may be configured to store information within accelerometer system 100 during operation. The memory may include a computer-readable storage medium or computer-readable storage device. In some examples, the memory includes one or more of a short-term memory or a long-term memory. The memory may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, the memory is used to store program instructions for execution by processing circuitry 102.

Processing circuitry 102 may generate the first electrical signal and the second electrical signal as a part of a one or more negative feedback loops which maintain proof mass element 104 in the null position. Processing circuitry 102, first coil 110A, and first sensor 112A represent components of a first negative feedback loop. The first negative feedback loop may maintain a width of the gap between proof mass element 104 and first non-moving member 108A at a first null width. For example, first sensor 112A may generate the first sense signal which indicates a capacitance value. The capacitance value is correlated with the width of the gap between proof mass element 104 and first non-moving member 108A and delivers the first sense signal to processing circuitry 102. Processing circuitry 102 may generate the first electrical signal based on the first sense signal and deliver the first electrical signal to first coil 110A in order to maintain the capacitance value of the first sense signal at a first null capacitance value. By generating the first electrical signal in order to maintain the capacitance value of the first sense signal at the first null capacitance value, processing circuitry 102 maintains a width of the gap between the proof mass element 104 and the first non-moving member 108A at the first null width.

Processing circuitry 102, second coil 110B, and second sensor 112B represent components of a second negative feedback loop. The second negative feedback loop may maintain a width of the gap between proof mass element 104 and second non-moving member 108B at a second null width. For example, second sensor 112B may generate the second sense signal which indicates a second capacitance value. The capacitance value is correlated with the width of the gap between proof mass element 104 and second non-moving member 108B and delivers the second sense signal to processing circuitry 102. Processing circuitry 102 may generate the second electrical signal based on the second sense signal and deliver the second electrical signal to second coil 110B in order to maintain the capacitance value of the second sense signal at a second null capacitance value. By generating the second electrical signal in order to maintain the second capacitance value of the second sense signal at the second null capacitance value, processing circuitry 102 maintains a width of the gap between the proof mass element 104 and the second non-moving member 108B at the second null width.

Additionally, by maintaining the width of the gap between the proof mass element 104 and the first non-moving member 108A at the first null width and maintaining the width of the gap between the proof mass element 104 and the second non-moving member 108B at the second null width, processing circuitry 102 may maintain a position of proof mass element 104 at a null position relative to non-moving members 108.

When an acceleration of accelerometer system 100 along a sense axis changes, the resulting acceleration force applied to proof mass element 104 may change. Consequently, processing circuitry 102 may change a magnitude of the first electrical signal delivered to first coil 110A and the second electrical signal delivered to second coil 110B in order to prevent a displacement of proof mass element 104 relative to non-moving members 108. In one example, the acceleration along the sense axis may increase from a first acceleration value to a second acceleration value. Processing circuitry 102 may change the magnitude of the first electrical signal and change the magnitude of the second electrical signal in order to account for the change in acceleration so that proof mass element 104 remains in the null position relative to non-moving members 108. Processing circuitry 102 may determine the acceleration of accelerometer system 100 along the sense axis based on the magnitude of the first electrical signal delivered to first coil 110A and the magnitude of the second electrical signal delivered to second coil 110B.

In some examples, the magnitude of the first electrical signal delivered to first coil 110A is proportional to the acceleration along the sense axis. In some examples, the magnitude of the second electrical signal delivered to second coil 110B is proportional to the acceleration along the sense axis. As such, an increase in the magnitude of the first electrical signal may correspond to an increase in the acceleration along the sense axis and an increase in the magnitude of the second electrical signal may correspond to an increase in the acceleration along the sense axis. Alternatively, a decrease in the magnitude of the first electrical signal may correspond to a decrease in the acceleration along the sense axis and a decrease in the magnitude of the second electrical signal may correspond to a decrease in the acceleration along the sense axis.

Accelerometer system 100 may include a first magnetic flux loop and a second magnetic flux loop. The first magnetic flux loop may include first pole piece 106A, first non-moving member 108A, and first coil 110A. Within the first magnetic flux loop, a first magnetic flux may travel from first pole piece 106A through first coil 110A to first non-moving member 108A. The first magnetic flux then travels through first non-moving member 108A back to first pole piece 106A. In some examples, first pole piece 106A may include a first magnet which generates the first magnetic flux. The second magnetic flux loop may include second pole piece 106B, second non-moving member 108B, and second coil 110B. Within the second magnetic flux loop, a second magnetic flux may travel from second pole piece 106B through second coil 110B to second non-moving member 108B. The second magnetic flux then travels through second non-moving member 108B back to second pole piece 106B. In some examples, second pole piece 106B may include a second magnet which generates the second magnetic flux.

Accelerometer system 100 may represent a servo system which counter-balances acceleration along the sense axis with Lorentz forces parallel to the sense axis. For example, if accelerometer system 100 accelerates along the sense axis, the acceleration may apply an acceleration force to the proof mass element 104, where the acceleration force is applied to proof mass element 104 in an opposite direction of the acceleration of accelerometer system 100. Processing circuitry 102 delivers the first electrical signal to first coil 110A and delivers the second electrical signal to second coil 110B in order to generate one or more Lorentz forces which counter-balance the acceleration force resulting from the acceleration along the sense axis. That is, the one or more Lorentz forces are applied to proof mass element 104 in an opposite direction to the acceleration force, such that proof mass element 104 is not displaced from a null position by the acceleration force. The magnitude of the acceleration force changes based on the magnitude of the acceleration along the sense axis. As such, to prevent the displacement of proof mass element 104 from the null position, processing circuitry 102 changes the magnitude of the first electrical signal delivered to first coil 110A and the magnitude of the second electrical signal delivered to second coil 110B in order to change the magnitude of the one or more Lorentz forces which counter-balance the acceleration signal.

Lorentz forces are forces which arise from an interaction between an electrical field and a magnetic field. As discussed above, accelerometer system 100 includes a first magnetic flux loop and a second magnetic flux loop. The first magnetic flux loop includes a passage of a first magnetic flux from the pole piece 106A to first non-moving member 108A through first coil 110A. The first electrical signal flows through first coil 110A. The first magnetic flux and the first electrical signal may cause a first Lorentz force to be applied to proof mass element 104 in an opposite direction of the acceleration force applied to proof mass element 104 due to the acceleration along the sense axis. Additionally, the second magnetic flux loop includes a passage of a second magnetic flux from the second pole piece 106B to second non-moving member 108B through second coil 110B. The second electrical signal flows through second coil 110B. The second magnetic flux and the second electrical signal may cause a second Lorentz force to be applied to proof mass element 104 in an opposite direction of the acceleration force applied to proof mass element 104 due to the acceleration along the sense axis.

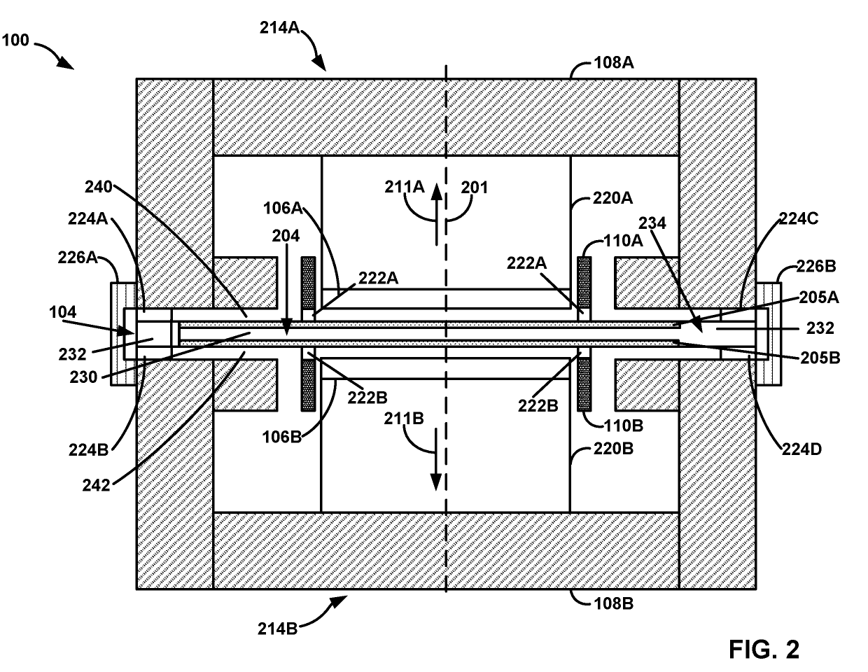

FIG. 2 is a conceptual diagram illustrating a side cutaway view of accelerometer system 100, in accordance with one or more techniques of this disclosure. As seen in FIG. 2, accelerometer system 100 includes proof mass element 104, first pole piece 106A, second pole piece 106B, first non-moving member 108A, second non-moving member 108B, first coil 110A, second coil 110B, first magnet 220A, and second magnet 220B (collectively, “magnets 220”). Proof mass assembly 204 includes proof mass element 104, first capacitive plate 205A, and second capacitive plate 205B (collectively, “capacitive plates 205”). In the example of FIG. 2, accelerometer system 100 further includes outer raised pads 224A–224D (collectively, “outer raised pads 224”), first band 226A, second band 226B (collectively, “bands 226”), first capacitive gap 240, and second capacitive gap 242. In the example of FIG. 2, accelerometer system 100 may include accelerometer supports 214A–214B (collectively, “accelerometer supports 214”), which may be formed by a combination of pole pieces 106, non-moving members 108, and magnets 220.

Accelerometer system 100 may be configured to sense an acceleration along sense axis 201. For example, accelerometer system 200 may be configured to sense an acceleration along sense axis 201 in a first direction 211A. In some cases, accelerometer system 200 precisely determines a magnitude of the acceleration along the sense axis 201 in the first direction 211A in real time or near-real time such that processing circuitry (not illustrated in FIG. 2) may track a position of accelerometer system 200 using dead reckoning.

As seen in FIG. 2, proof mass assembly 204 is suspended between first non-moving member 108A and second non-moving member 108B by outer raised pads 224. Proof mass element 104 may include a suspended portion 230 and a support portion 232. Support portion 232 may be disposed between and/or secured to outer raised pads 224. Support portion 232 may be secured to non-moving members 108, e.g., via outer raised pads 224. Suspended portion 230 may be disposed radially inwards of support portion 232 and may be connected to support portion 232 via one or more flexures 234. Aside from the connection(s) between suspended portion 230 and support portion 232 formed by flexure(s) 234, proof mass element 104 may define a gap between suspended portion 230 and support portion 232, e.g., to allow for movement of suspended portion 230 relative to support portion 232.

Coils 110 may be disposed on suspended portion 230. Coils 110 may be attached to suspended portion 230 via center raised pads 222A–B (collectively referred to herein as “center raised pads 222”). Suspended portion 230 may move (e.g., along sensing axis 201) into and/or out of a null position along sensing axis 201. Capacitive plates 205 may be disposed on the outer surfaces of suspended portion of proof mass element 104. Movement of suspended portion 230 relative to support portion 232 may lead to changes in the widths of capacitive gaps 240, 242. Coils 110 and/or capacitive plates 205 may be electrically connected to processing circuitry 102 of accelerometer system 100 via electrical traces extending from suspended portion 230 to support portion 232 along flexure(s) 234.

In some examples, processing circuitry 102 (not pictured in FIG. 2) may receive a first sensed signal indicative of a width of first capacitive gap 240 and receive a second sensed signal indicative of a width of second capacitive gap 242. In turn, processing circuitry 102 may deliver a first electrical signal to first coil 110A and deliver a second electrical signal to second coil 110B in order to prevent a displacement of proof mass element 104 (e.g., of suspended portion 230) in response to an acceleration of accelerometer system 100 along sense axis 201. The magnitude of the first electrical signal and the magnitude of the second electrical signal may be correlated with the magnitude of the acceleration.

Non-moving members 108 may be attached to outer raised pads 224, securing proof mass assembly 204 (e.g., support portion 232 of proof mass element 104) between first non-moving member 108A and second non-moving member 108B. The term “non-moving member” may refer to a member representing a reference position by which a position of proof mass assembly 204 may be compared. In other words, the position of proof mass assembly 204 may represent a position of proof mass assembly 204 relative to non-moving members 108. In some examples, non-moving members 108 include dual metal materials, which may be part of a magnetic flux loop. In some examples, non-moving members 108 may be similar to stators of a variable capacitor.

Coils 110 may conduct electricity such that electrical signals flow through coils 110. For example, a first electrical signal may flow through a path of first coil 110A and a second electrical signal may flow through a path of second coil 110B. The path of each of coils 110 may define a circular, oval, square, triangular, or other polygonal path. Each of coils 110 extend fully around an outer surface of a corresponding pole piece of pole pieces 106, e.g., such that the first electrical signal flows around the outer surface of pole piece 106A through first coil 110A and the second electrical signal flows around the outer surface of pole piece 106B through second coil 110B.

Bands 226 are a metal pieces which fasten first non-moving member 108A to second non-moving member 108B. In some examples, bands 226 may be attached to (e.g., bonded with epoxy) non-moving members 108, when non-moving members 108 are attached to proof mass assembly 204 by outer raised pads 224. Accelerometer system 100 includes first capacitive gap 240 and second capacitive gap 242. First capacitive gap 240 represents a gap between first capacitive plate 205A and first non-moving member 108A, second capacitive gap 242 represents a gap between second capacitive plate 205B and second non-moving member 108B. First capacitive plate 205A may generate a first sense signal which indicates a first capacitance value. The first capacitance value is correlated with a width of first capacitive gap 240. Second capacitive plate 205B may generate a second sense signal which indicates a second capacitance value. The second capacitance value is correlated with a width of second capacitive gap 242. In this way, first capacitive plate 205A may represent first sensor 112A of FIG. 1 and second capacitive plate 205B may represent second sensor 112B of FIG. 1. Processing circuitry 102 (not illustrating in FIG. 2) may receive the first sense signal and the second signal and control electrical signals delivered to coils 110 based on the first sense signal and the second sense signal.

In some examples, the null width of first capacitive gap 240 is within a range from 0.0127 millimeters (mm) (e.g., about 0.0005 inches (in)) to 0.0635 mm (e.g., about 0.0025 in). In some examples, the null width of second capacitive gap 242 is within a range from 0.0127 mm (e.g., about 0.0005 in) to 0.0635 mm (e.g., about 0.0025 in). When the width of first capacitive gap 240 is at the null width of first capacitive gap 240 and the width of second capacitive gap 242 is at the null width of second capacitive gap 242, proof mass element 104 may be located at a null position. That is, proof mass element 104 may be located at the null position such that processing circuitry 102 is configured to determine the acceleration along sense axis 201 based on the first electrical signal delivered to first coil 110A and the second electrical signal delivered to second coil 110B.

In some examples, first capacitive gap 240 may have a first capacitance value. Processing circuitry 102 may detect the first capacitance value of first capacitive gap 240, which in a closed-loop differential capacitance configuration can be detected and used by processing circuitry 102 to determine the acceleration of accelerometer system 100. Additionally, second capacitive gap 242 may have a second capacitance value. Processing circuitry 102 may detect the second capacitance value of second capacitive gap 242, which in a closed-loop differential capacitance configuration can be detected and used by processing circuitry 102 to determine the acceleration of accelerometer system 100. In some examples, an increase in a width of first capacitive gap 240 and a decrease in a width of second capacitive gap 242 may be indicative of an acceleration of accelerometer system 100 in first direction 211A. Conversely, an increase in the width of second capacitive gap 242 and a decrease in the width of first capacitive gap 240 may be indicative of an acceleration of accelerometer system 200 in the second direction 211B. Processing circuitry 102 may deliver the first electrical signal to first coil 110A and deliver the second electrical signal to second coil 110B in order to counter-balance a displacement of proof mass element 104 from the null position. The magnitude of the first electrical signal and the magnitude of the second electrical signal may be correlated with the magnitude of the acceleration along sense axis 201.

Magnets 220 are magnets for providing a magnetic field to drive magnetic circuits of magnets 220, pole pieces 106, coils 110, and non-moving members 108. In some examples, magnets 220 may be made of Alnico, samarium-cobalt, neodymium-iron-boron, or other such materials. In some examples, magnets 220 may receive the forces and/or strains transmitted from non-moving members 208 caused by the construction of accelerometer system 100. In some examples, magnets 220 may be part of a zero-gauge configuration of accelerometer system 100.

Pole pieces 106 are magnetic structures that enable the magnetic field of magnets 220 to be focused and drive the magnetic circuit of magnets 220, pole pieces 106, coils 110, and non-moving members 108. For example, pole pieces 106 may be magnetic structures that enable the magnetic field of the magnet to turn a corner and flow through coils 110. In these examples, by allowing the magnetic field of magnets 220 to go through coils 110, the magnetic field of magnets 220 may enter non-moving members 108 and flow around to the opposite side of the magnet through non-moving members 108, and flow back through the magnet to the proof mass completing the magnetic circuit. For example, a first magnetic circuit may represent a magnetic flux loop in which a first magnetic flux passes from first magnet 220A to first pole piece 106A. The first magnetic flux travels from first pole piece 106A to first non-moving member 108A through first coil 110A. Then, the first magnetic flux travels through first non-moving member 108A back to first magnet 220A in order to complete the first magnetic circuit. A second magnetic circuit may represent a magnetic flux loop in which a second magnetic flux passes from second magnet 220B to second pole piece 106B. The second magnetic flux travels from second pole piece 106B to second non-moving member 108B through second coil 110B. Then, the second magnetic flux travels through second non-moving member 108B back to second magnet 220B in order to complete the second magnetic circuit.

In some examples, pole pieces 106 may be part of a zero-gauge configuration of accelerometer system 100. In some examples, pole pieces 106 may be made from a permeable material such as invar, Mu Metal, Permalloy, or other such material.

Preventing proof mass element 104 from displacing form the null position may be referred to herein as the “servo effect.” In some examples, processing circuitry 102 may cause one or more Lorentz forces to counterbalance an acceleration force applied to proof mass element 104 such that proof mass element 104 does not move from the null position. This means that processing circuitry 102 is configured to adjust the one or more Lorentz forces in real time or near-real time such that the one or more Lorentz forces counter-balance the acceleration force applied to proof mass element 104 at any given time, thus constantly maintaining the proof mass element 104 at the null position. The electrical signals required to induce the one or more Lorentz forces may be generated by processing circuitry 102 based on the first sense signal received from first capacitive plate 205A and the second sense signal received from the second capacitive plate 205B. In some examples, processing circuitry may modify the current in coils 110 to servo proof mass element 104 to maintain the null position. Any acceleration of accelerometer system 100 will momentarily move the proof mass of proof mass assembly 204 out of the plane of the null position and the increase in current required to maintain proof mass element 104 in the null position is proportional to the magnitude of the acceleration of accelerometer system 100 along sense axis 201.

Although FIG. 2 illustrates accelerometer system 100 with a capacitive plate and a coil on both sides of proof mass assembly 204 to form a combined capacitive pick-off system, it is understood that accelerometer system 100 may function with a capacitor plate and a coil on only one side of proof mass assembly 204. Similarly, although FIG. 2 illustrates accelerometer system 100 with a non-moving member on both sides of proof mass assembly 204 to form the combined capacitive pick-off system, it is understood that accelerometer system 100 may function a non-moving member and a capacitor plate on the same side of proof mass assembly 204.

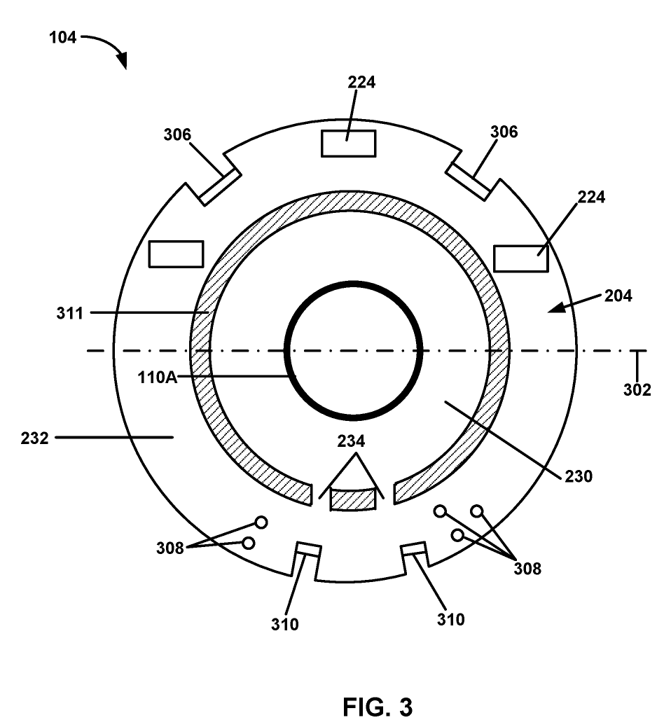

FIG. 3 is a conceptual diagram illustrating an example proof mass element 104 of system 100 of FIGS. 1–2. While FIG. 3 illustrates one surface of proof mass assembly 204 of proof mass element 104, an opposite surface of proof mass assembly 204 may be identical to the surface illustrated in FIG. 3.

Proof mass assembly 204 of proof mass element 104 may include suspended portion 230, support portion 232, and flexure(s) 234 connecting suspended portion 230 to support portion 232. Suspended portion 230 may be disposed radially inwards of support portion 232. Support portion 232 may be held in place within system 100 by non-moving members 108. Suspended portion 230 may be separated from support portion 232 by gap 311, with one or more flexure(s) 234 extending across gap 311 and connecting suspended portion 230 to support portion 232. Suspended portion 230 may be configured to displace away from a reference plane defined by support portion 232 in response to acceleration of system 100. Suspended portion 230, support portion 232, and flexure(s) 234 may be formed from a single element and/or may define a monolithic component. Aside from flexure(s) 234, suspended portion 230.

Coils 110 may be disposed on suspended portion 230, e.g., on opposite sides on suspended portion 230. Each of coils 110 may be electrically connected to pin(s) 308 on support portion 232 via trace(s) (not pictured in FIG. 3) extending along flexure(s) 234. Pin(s) 308 may electrically connect coils 110 to one or more other components of system 100 (e.g., to processing circuitry 102 of system 100).

Support portion 232 may include one or more outer raised pads 224 on the surface of support portion 232. Outer raised pads 224 may be arranged around an outer perimeter of support portion 232 (e.g., at one or more locations opposite flexure(s) 234). Support portion 232 may define a plurality of first recesses 306 (e.g., above a rotational axis 302 of proof mass assembly 204) and a plurality of second recesses 310 (e.g., below rotational axis 302). In some examples, as illustrated in FIG. 3, first recesses 306 and second recesses 310 are disposed on opposite halves of proof mass assembly 204. In some examples first recesses 306 and second recesses 310 are disposed on a same half of proof mass assembly 304.

Each of recesses 306, 310 may extend from one surface of support portion 232 towards an opposite surface of support portion 232. First recesses 306 may be disposed between circumferentially adjacent outer raised pads 224. Second recesses 310 may be disposed at or around flexure(s) 234 and/or pins 308.

Recesses 306, 310 may be electrically coupled to one or more of an outer surface of proof mass assembly 204, pins 308, and/or trace(s) on proof mass assembly 204 (e.g., along flexure(s) 234). Recesses 306, 310 may be configured to retain wire bonds along a wire electrically connecting opposite surfaces of proof mass assembly 204. When proof mass assembly 204 is disposed within a manufacturing device (e.g., while within a fixture). A manufacturing assembly may form, via a bonding device, a first bond within one recess on a first surface of proof mass assembly 204 (e.g., recesses 306, 310), rotate proof mass assembly within the fixture by 180 degrees (e.g., about rotational axis 302), and form, via the bonding device, a second bond within another recess on an opposite surface of proof mass assembly 204. For example, the manufacturing assembly may form a first bond within one first recess 306 on an upper surface of proof mass assembly 204 and a second bond within one second recess 310 on a lower surface of proof mass assembly 204. Any other combination of recesses 306, 310 may be selected to retain the first and second bonds.

The first and second bonds may be along a same wire and may be electrically coupled components on the opposite surfaces of proof mass assembly 204. Each bond may be electrically connected to a trace, pin 308, or component (e.g., one of coils 110, one of capacitive plates 205). An evaporant may be disposed over outer surfaces of proof mass assembly 204 and surfaces of recess 306, 310 (e.g., via a metallization process). The evaporant may include an electrically conductive material (e.g., a platinum alloy, a platinum-gold alloy). The evaporant may include a bonding layer such as chromium or tantalum to assure good adhesion of the conductive layer to the substrate. The electrically conductive material may electrically connect surfaces within recesses 306, 310, to components disposed on the outer surfaces of proof mass assembly 204. The manufacturing assembly may form different pairs of first and second bonds (e.g., within different combinations of recesses 206, 210) for different components on proof mass assembly 204. For example, the manufacturing assembly may form a plurality of bond pairs, with one bond pair for each of capacitive plates 205 and/or for each of coils 110.

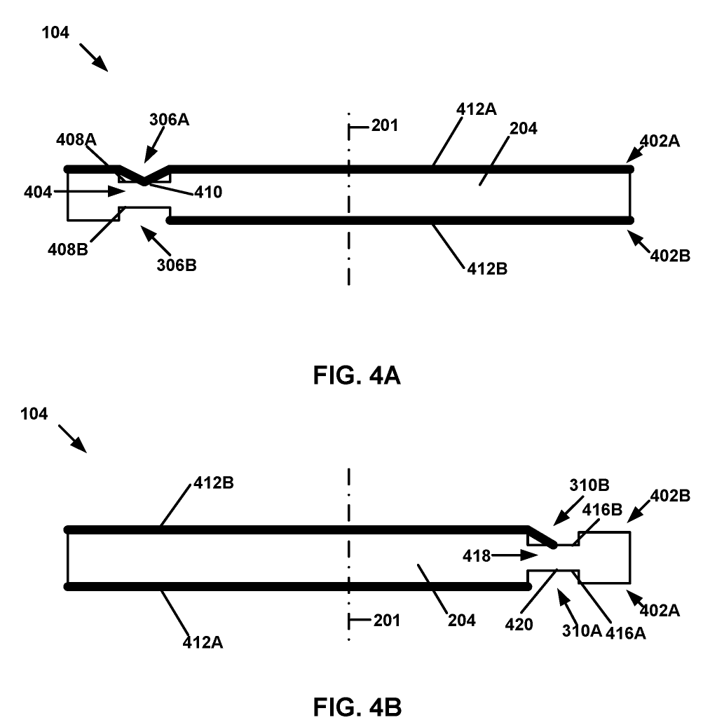

FIG. 4A is a conceptual diagram illustrating a first wire bond 410 to a first surface 402A of proof mass element 104 of FIG. 3. FIG. 4B is a conceptual diagram illustrating a second wire bond 420 to a second surface 402B of proof mass element 104 of FIG. 3. First wire bond 410 may electrically couple first wire portion 412A to first surface 402A and second wire bond 420 may electrically couple second wire portion 412B to second surface 402B. First wire portion 412A may be electrically connected to second wire portion 412B, e.g., thereby electrically connecting first surface 402A to second surface 402B. First surface 402A may be opposite to and parallel to second surface 402B.

A manufacturing assembly may dispose first wire portion 412A over first surface 402A of proof mass assembly 204. First wire portion 412A may be formed from a conductive material including, but not limited to, gold. First wire portion 412A may be electrically coupled to one or more elements on first surface 402A (e.g., pin 308, trace, coil 110, or conductive plate 205) on first surface 402A. First wire portion 412A may be disposed on support portion 232 of proof mass assembly 204.

The manufacturing assembly may dispose first wire portion 412A within first recess 306A. Proof mass assembly 204 may define pairs of first recesses 306. For example, as illustrated in FIG. 4A, proof mass assembly 204 may define first recess 306A extending from first surface 402A towards second surface 402B and second recess 306B extending from second surface 402B towards first surface 402A. Each of first recess 306A, 306B may define a blind recess and may be separated by portion 404 of proof mass assembly 204. First recess 306A may define a bottom surface 408A and first recess 306B may define a bottom surface 408B. Bottom surfaces 408A, 408B (collectively referred to herein as “bottom surfaces 408”) may be coated with an electrically conductive material, e.g., to electrically couple bottom surfaces 408A, 408B to surfaces 402A, 402B, respectively.

The manufacturing assembly may form first wire bond 410 along first wire portion 412A within first recess 306 (e.g., within first recess 306A). First wire bond 410 may affix and electrically couple first wire portion 412A to bottom surface 408A of first recess 306A. The manufacturing assembly may form first wire bond 410 via a wedge bonding technique (e.g., via an ultrasonic bonding technique). The manufacturing assembly may form first wire bond 410 via a bonding device aligned towards first surface 402A.

After formation of first wire bond 410, the manufacturing assembly may rotate proof mass assembly 204 (e.g., about rotational axis 302 of FIG. 3) to align the bonding device with second surface 402B. The manufacturing assembly may dispose second wire portion 412B over second surface 402B. Second wire portion 412B may be connected to first wire portion 412A. In some examples, first and second wire portions 412A, 412B may be along a same wire and second wire portion 412B may be distal to first wire portion 412A along the same wire. In some examples, second wire portion 412B is separate from and electrically connected to first wire portion 412A, e.g., at or around first wire bond 410. Second wire portion 412B may be electrically coupled to one or more elements on second surface 402B (e.g., trace(s), pin(s) 308, coil 110, capacitive plate 205) and/or to second surface 402B.

The manufacturing assembly may dispose an end of second wire portion 412B within second recess 310A. Proof mass assembly 204 may define pairs of first recesses 310. For example, as illustrated in FIG. 4B, proof mass assembly 204 may define first recess 310A extending from first surface 402A towards second surface 402B and second recess 310B extending from second surface 402B towards first surface 402A. Each of second recesses 306A, 306B may define a blind recess and may be separated by portion 418 of proof mass assembly 204. Second recess 310A may define a bottom surface 416A and second recess 310B may define a bottom surface 408B. Bottom surfaces 416A, 416B (collectively referred to herein as “bottom surfaces 416”) may be coated with an electrically conductive material, e.g., to electrically couple bottom surfaces 416A, 416B to surfaces 402A, 402B, respectively.

The manufacturing assembly may form second wire bond 420 along second wire portion 41BA within second recess 310 (e.g., within second recess 310B). Second wire bond 420 may affix and electrically couple second wire portion 412B to bottom surface 416B of second recess 310B. The manufacturing assembly may form second wire bond 420 via a wedge bonding technique (e.g., via an ultrasonic bonding technique).

First and second wire bonds 410, 420 may electrically connect elements on surfaces 402A, 402B. While FIGS. 4A – 4B illustrate first wire bond 410 being disposed in first recess 306A and second wire bond 420 being disposed in second recess 310B, wire bonds 410, 420 may be disposed in any other combination of recesses on opposite surfaces 402 of proof mass assembly 204. For example, first wire bond 410 may be disposed in first recess 306A and second wire bond 420 may be disposed in second recess 306B. In another example, first wire bond 410 may be disposed in second recess 310A and second wire bond 420 may be disposed in second recess 310B. Together, first and second wire bonds 410, 420 may form a parallel gap weld between first surface 402A and second surface 402B.

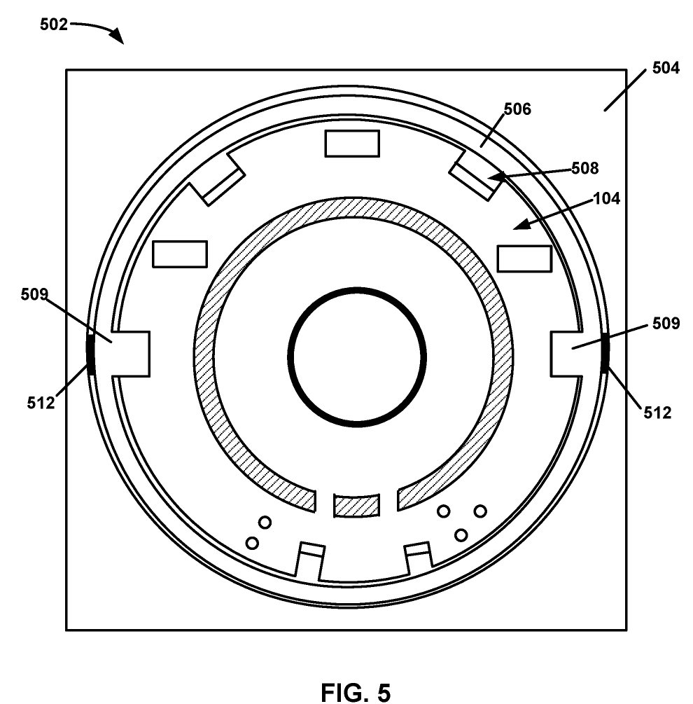

FIG. 5 is a conceptual diagram illustrating a fixture 502 retaining proof mass element 104 of FIGS. 3–4B. Fixture 502 define a fixture body 504 and a rotatable element 506 coupled to fixture body 504. Rotatable element 506 may be configured to retain proof mass element 104 within fixture 502.

Fixture body 504 may be configured to be disposed within and be secured within a manufacturing assembly (e.g., within a metallization assembly). Rotatable element 506 may be rotatable within fixture body 504. Rotatable element 506 may be configured to rotate relative to fixture body 504, e.g., when fixture body 504 is affixed within the manufacturing assembly. Rotatable element 506 may define a rotatable ring. Rotatable element 506 may be coupled to fixture body 504 via one or more connectors 512. Connector(s) 512 may allow for rotation of rotatable element 506 relative to fixture body 504.

Rotatable element 506 may define an inner receptacle 508 sized to retain proof mass element 104. Rotatable element 506 may define one or more locking elements 509 (e.g., tabs, extensions, protrusions, or the like). Locking element(s) 509) may secure proof mass element 104 to rotatable element 506, e.g., during the manufacturing process and/or during rotation of rotatable element 506 within fixture body 504. Locking element(s) 509 may partially or may not obscure any portion of surfaces 402 of proof mass element 104.

During manufacturing, the manufacturing assembly may retain fixture 502 containing proof mass element 104, e.g., within a metallization assembly. The manufacturing assembly may dispose the evaporant over one of surfaces 402 of proof mass element 104, rotate rotatable element 506 and proof mass element 104 180 degrees within fixture body 504, and dispose the evaporant over the opposite surface of surfaces 402. Rotation of proof mass element 104 via fixture 502 may allow for a uniform deposition of evaporant over both surfaces 402, e.g., thereby reducing vias in system 100 due to variations in the thickness of the evaporant over surfaces 402.

The manufacturing assembly may form first and second wire bonds 410, 420 on proof mass element 104 while proof mass element 104 is secured within fixture 502. The manufacturing assembly may form first wire bond 410 in a recess on a first surface of surfaces 402 of proof mass element 104, rotate proof mass element 104 within fixture 502 via rotatable element 506, and form second wire bond 420 in a recess on an opposite surface of surfaces 402 of proof mass element 104. Using fixture 502 to rotate proof mass element 104 may simplify the process of forming wire bonds 410, 420, e.g., by simplifying the process of re-positioning proof mass element 104 between forming first wire bond 410 and forming second wire bond 420.

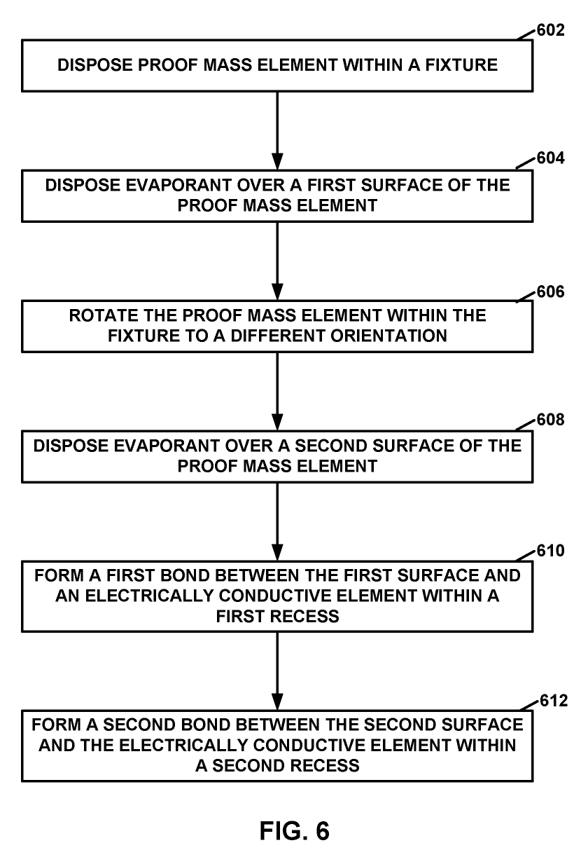

FIG. 6 is a flow chart illustrating an example technique for manufacturing proof mass element 104 of FIGS. 1–5. While the technique illustrated in FIG. 6 is primarily described with reference to proof mass element 104 of FIGS. 1–5, the technique may be performed to manufacturing any other proof mass element described herein. While the technique is primarily described below as being performed by a manufacturing assembly, the process may be performed by one or more manufacturers and/or operators using one or more separate manufacturing devices.

The manufacturing assembly may dispose proof mass element 104 within fixture 502 (602). Fixture 502 may define fixture body 504 containing rotatable element 506. Rotatable element 506 may be configured to freely rotate within fixture body 504.

Rotatable element 506 may define an inner receptacle 508 sized to retain proof mass element 104. The manufacturing assembly may dispose proof mass element 104 within inner receptacle 508 and secure proof mass element 104 to rotatable element 506 via locking element(s) 509 on rotatable element 506. Proof mass element 104 may define suspended portion 230, supported portion 232, and flexure(s) 234 connecting suspended portion 230 to support portion 232. Proof mass element 104 may define a single, monolithic element. Proof mass element 104 may define recesses (e.g., first recesses 306, second recesses 310) on support portion 232. Recesses may be formed on proof mass element 104 by the manufacturing assembly via one or more techniques including, but are not limited to, selective laser etching (SLE).

The manufacturing assembly may dispose evaporant over a first surface 402A of proof mass element 104 (604). The manufacturing assembly may insert fixture 502 containing proof mass element 104 into a manufacturing device (e.g., a metallization device, an evaporator, a sputtering machine, or the like). Fixture 502 may orient first surface 402A of proof mass element 104 towards a nozzle of the manufacturing device. The manufacturing assembly may cause the manufacturing device to dispose the evaporant from the nozzle over first surface 402A, e.g., to metallize first surface 402A. The evaporant may include an electrically conductive metallic material including, but are not limited to, a platinum alloy, a platinum-gold alloy, or the like. The manufacturing device may dispose the evaporant over bottom surfaces of recesses on first surface 402A (e.g., bottom surfaces 408A of first recesses 306A on first surface 402A, bottom surfaces 416A of second recesses 310A on first surface 402A). The evaporant may electrically connect the bottom surfaces of the recesses on first surface 402A to elements on first surface 402A (e.g., pins 308, first surface 402A).

When disposed, the evaporant may define a first pattern over first surface 402A. At least a portion of first surface 402A may be covered, e.g., by a masking material. When the evaporant is disposed over first surface 402A, the masking material may cover or obscure selected portions (e.g., the covered portions) of first surface 402A, e.g., to define the first pattern over first surface 402A. The covered portions may be removed after disposal of the evaporant and may not be coated with the evaporant.

The manufacturing assembly may rotate proof mass element 104 within fixture 502 to a different orientation (606). Rotatable element 506 of fixture 502 may rotate with fixture body 504 while fixture 502 is secured within the manufacturing device. The manufacturing assembly may rotate rotatable element 506 within fixture 502 to cause proof mass element 104 to rotate about rotational axis 302. The manufacturing assembly may rotate proof mass element 104 by 180 degrees about rotational axis 302 to orient second surface 402B of proof mass element 104 towards the nozzle of the manufacturing device.

The manufacturing assembly may dispose evaporant over second surface 402B of proof mass element 104 (608). The manufacturing assembly may cause the manufacturing device to dispose the evaporant from the nozzle over second surface 402B, e.g., to metallize second surface 402B. The manufacturing device may dispose the evaporant over bottom surfaces of recesses on second surface 402B (e.g., bottom surfaces 408B of first recesses 306B on second surface 402B, bottom surfaces 416B of second recesses 310B on second surface 402B). The evaporant may electrically connect the bottom surfaces of the recesses on second surface 402B to elements on second surface 402B (e.g., pins 308, second surface 402B).

When disposed, the evaporant may define a second pattern over second surface 402B. At least a portion of second surface 402B may be covered, e.g., by a masking material. When the evaporant is disposed over second surface 402B, the masking material may cover or obscure selected portions (e.g., the covered portions) of second surface 402B, e.g., to define the second pattern over second surface 402B. The covered portions of second surface 402B may be removed after disposal of the evaporant and may not be coated with the evaporant. The second pattern may be the same as or different from the first pattern.

The manufacturing assembly may form a first wire bond 410 between first surface 402A and an electrically conductive element (e.g., a wire) within one of first recesses 306A (610). The manufacturing assembly may orient fixture 502 containing proof mass element 104 towards a bonding device, e.g., to orient first surface 402A towards the bonding device. The bonding device may include a wire bonding device. The manufacturing assembly may dispose a first wire portion 412A of the electrically conductive element over first surface 402A and/or couple first wire portion 412A to an element on first surface 402A (e.g., to a trace, to a pin 308, to coil 110A, to capacitive plate 205A).

The manufacturing assembly may dispose first wire portion 412A within first recess 306A. The manufacturing assembly may cause the bonding device to form first wire bond 410 between first wire portion 412A and bottom surface 408A of first recess 306A. First wire bond 410 may electrically couple first wire portion 412A to bottom surface 408A. The bonding device may form first wire bond 410 via a wedge bonding or ultrasonic bonding technique. First wire bond 410 may be flush with and/or may not be proud of an outer edge of first recess 306A.

The manufacturing assembly may form a second wire bond 420 between second surface 402B and the electrically conductive element within one of second recesses 310B (612). The manufacturing assembly may, after forming first wire bond 410, rotate proof mass element 104 within fixture 502 (e.g., by rotating rotatable element 504) to orient second surface 402B towards the bonding device. The manufacturing assembly may dispose a second wire portion 412B of the electrically conductive element over second surface 402B and/or couple second wire portion 412B to an element on second surface 402B (e.g., to a trace, to a pin 308, to coil 110B, to capacitive plate 205B). Second wire portion 412B may be of a same wire as first wire portion 412A. In some examples, second wire portion 412B is of a different wire than first wire portion 412A and is electrically coupled to first wire portion 412A (e.g., at or around first wire bond 410).

The manufacturing assembly may dispose second wire portion 412B within second recess 310B. The manufacturing assembly may cause the bonding device to form second wire bond 420 between second wire portion 412B and bottom surface 416B of second recess 310B. Second wire bond 420 may electrically couple second wire portion 412B to bottom surface 416B. The bonding device may form second wire bond 420 via a wedge bonding or ultrasonic bonding technique. Second wire bond 420 may be flush with and/or may not be proud of an outer edge of second recess 310B.

While the technique illustrated above is primarily described with respect to forming first wire bond 410 in first recess 306A and second wire bond 420 in second recess 310, the techniques described above may be applied to form first wire bond 410 in one or more other recesses on first surface 402A and to form second wire bond 420 in one or more other recesses on second surface 402B. For example, the manufacturing assembly may form first wire bond 410 in one or more of first recesses 306A or second recesses 310A. In another example, the manufacturing assembly may form second wire bond 420 in one or more of first recesses 306B or second recesses 310B.

This disclosure describes the following examples:

Example 1: a proof mass element of an accelerometer, the proof mass element defining: a first surface; a second surface parallel with the first surface; and two or more recesses, wherein each recess of the two or more recesses extends from one of the first surface or the second surface towards the other of the first surface or the second surface; wherein the first surface is coupled to an electrically conductive element through a first bond within a first recess of the two or more recesses, wherein the second surface is coupled to the electrically conductive element within a second recess of the two or more recesses through a second bond, the second recess being different from the first recess, and wherein the first surface is electrically coupled to the second surface via the electrically conductive element.

Example 2: the proof mass element of example 1, wherein the first bond comprises a wedge bond between the electrically conductive element and a first bottom surface of the first recess.

Example 3: the proof mass element of any of examples 1 and 2, wherein the first recess defines a first blind recess extending from the first surface towards the second surface, and wherein the second recess defines a second blind recess extending from the second surface towards the first surface.

Example 4: the proof mass element of any of examples 1–3, wherein the first recess and the second recess are disposed on a same half of the proof mass element.

Example 5: the proof mass element of any of examples 1–4, wherein the first recess and the second recess are disposed on opposite halves of the proof mass element.

Example 6: a proof mass element for an accelerometer, the proof mass element comprising: a first surface; a second surface parallel with the first surface; and two or more recesses, wherein each recess of the two or more recesses extends from one of the first surface or the second surface towards the other of the first surface or the second surface, wherein the first surface is electrically coupled to the second surface via a method comprising: affixing the proof mass element within a fixture in a first orientation; disposing an evaporant over the first surface of the proof mass element; rotating the proof mass element within the fixture from the first orientation to a second orientation, the second orientation being different to the first orientation; disposing the evaporant over the second surface of the proof mass element when the proof mass element is in the second orientation; forming a first bond between the first surface and an electrically conductive element within a first recess of the two or more recesses; and forming a second bond between the second surface and the electrically conductive element within a second recess of the two or more recesses, the second recess being different from the first recess.

Example 7: the proof mass element of example 6, wherein forming the first bond comprises forming a wedge bond between the electrically conductive element and a surface of the first recess.

Example 8: the proof mass element of any of examples 6 and 7, wherein rotating the proof mass element within the fixture from the first orientation to the second orientation comprises rotating the proof mass element up to 180 degrees about a reference plane orthogonal to a central axis of the proof mass element.

Example 9: the proof mass element of any of examples 6–8, wherein the first recess defines a first blind recess extending from the first surface towards the second surface, and wherein the second recess defines a second blind recess extending from the second surface towards the first surface.

Example 10: the proof mass element of any of examples 6–9, wherein disposing the evaporant over the first surface of the proof mass element comprises: covering at least a portion of the first surface with a masking material; and disposing the evaporant over the first surface of the proof mass element, wherein the masking material obscures the at least the portion of the first surface to cause the evaporant to define a first pattern over the first surface.

Example 11: the proof mass element of any of examples 6–10, wherein disposing the evaporant over the second surface of the proof mass element comprises: covering at least a portion of the second surface with a masking material; and disposing the evaporant over the second surface of the proof mass element, wherein the masking material obscures the at least the portion of the second surface to cause the evaporant to define a second pattern over the second surface.

Example 12: the proof mass element of any of examples 6–11, wherein the first recess comprises a first blind recess extending from the first surface towards the second surface, and wherein the first recess defines a first bottom surface electrically coupled to the first surface.

Example 13: the proof mass element of any of examples 6–12, wherein the first recess comprises a second blind recess extending from the second surface towards the first surface, and wherein the second recess defines a second bottom surface electrically coupled to the second surface.

Example 14: the proof mass element of any of examples 6–13, wherein the first recess and the second recess are disposed on a same half of the proof mass element.

Example 15: the proof mass element of any of examples 6–14, wherein the first recess and the second recess are disposed on opposite halves of the proof mass element.

Example 16: the proof mass element of any of examples 6–15, wherein the first bond and the second bond define a parallel gap weld between the first surface and the second surface.

Example 17: a fixture for a proof mass element of an accelerometer, the fixture comprising: a fixed portion; and a movable portion defining an opening configured to retain the proof mass element, wherein the proof mass element defines: a first surface; a second surface parallel with the first surface; and two or more recesses, wherein each recess of the two or more recesses extends from one of the first surface or the second surface towards the other of the first surface or the second surface, wherein the fixture is configured to rotate the proof mass element via rotation of the movable portion relative to the fixed portion, and wherein when the proof mass element is retained within the opening, the fixture is configured to expose the first surface, the second surface, and the two or more recesses to allow for: disposition of an evaporant over the first surface and the second surface; and formation of a first bond between the first surface and an electrically conductive element within a first recess of the two or more recesses; and formation of a second bond between the second surface and the electrically conductive element within a second recess of the two or more recesses, the second recess being different from the first recess.

Example 18: the fixture of example 17, wherein the movable portion is configured to rotate relative to the fixed portion to rotate the proof mass element up to 180 degrees about a reference plane orthogonal to a central axis of the proof mass element.

Example 19: the fixture of any of examples 17 and 18, wherein the fixture is configured to be secured within one or more devices, and wherein the movable portion is configured to rotate relative to the fixed portion when the fixture is secured within the one or more devices.

Example 20: the fixture of example 19, wherein the one or more devices comprises one or more of: an evaporator; a wire bonding device; or a sputtering machine.

In one or more examples, the accelerometers described herein may utilize hardware, software, firmware, or any combination thereof for achieving the functions described. Those functions implemented in software may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure.

Instructions may be executed by one or more processors within the accelerometer or communicatively coupled to the accelerometer. The one or more processors may, for example, include one or more DSPs, general purpose microprocessors, application specific integrated circuits ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for performing the techniques described herein. Also, the techniques could be fully implemented in one or more circuits or logic elements.

The techniques of this disclosure may be implemented in a wide variety of devices or apparatuses that include integrated circuits (ICs) or sets of ICs (e.g., chip sets). Various components, modules, or units are described in this disclosure to emphasize functional aspects of devices configured to perform the disclosed techniques, but do not necessarily require realization by different hardware units. Rather, various units may be combined or provided by a collection of interoperative hardware units, including one or more processors as described above, in conjunction with suitable software and/or firmware.

What is claimed is:

1. A proof mass element of an accelerometer, the proof mass element defining:
a first surface;
a second surface parallel with the first surface; and
two or more recesses, wherein each recess of the two or more recesses extends from one of the first surface or the second surface towards the other of the first surface or the second surface;
wherein the first surface is coupled to an electrically conductive element through a first bond within a first recess of the two or more recesses, wherein the second surface is coupled to the electrically conductive element within a second recess of the two or more recesses through a second bond, the second recess being different from the first recess, and wherein the first surface is electrically coupled to the second surface via the electrically conductive element.

2. The proof mass element of claim 1, wherein the first bond comprises a wedge bond between the electrically conductive element and a first bottom surface of the first recess.

3. The proof mass element of claim 1, wherein the first recess defines a first blind recess extending from the first surface towards the second surface, and wherein the second recess defines a second blind recess extending from the second surface towards the first surface.

4. The proof mass element of claim 1, wherein the first recess and the second recess are disposed on a same half of the proof mass element.

5. The proof mass element of claim 1, wherein the first recess and the second recess are disposed on opposite halves of the proof mass element.

6. A proof mass element for an accelerometer, the proof mass element comprising:
a first surface;
a second surface parallel with the first surface; and
two or more recesses, wherein each recess of the two or more recesses extends from one of the first surface or the second surface towards the other of the first surface or the second surface,
wherein the first surface is electrically coupled to the second surface via a method comprising:
affixing the proof mass element within a fixture in a first orientation;
disposing an evaporant over the first surface of the proof mass element;
rotating the proof mass element within the fixture from the first orientation to a second orientation, the second orientation being different to the first orientation;
disposing the evaporant over the second surface of the proof mass element when the proof mass element is in the second orientation;
forming a first bond between the first surface and an electrically conductive element within a first recess of the two or more recesses; and
forming a second bond between the second surface and the electrically conductive element within a second recess of the two or more recesses, the second recess being different from the first recess.

7. The proof mass element of claim 6, wherein forming the first bond comprises forming a wedge bond between the electrically conductive element and a surface of the first recess.

8. The proof mass element of claim 6, wherein rotating the proof mass element within the fixture from the first orientation to the second orientation comprises rotating the proof mass element up to 180 degrees about a reference plane orthogonal to a central axis of the proof mass element.

9. The proof mass element of claim 6, wherein the first recess defines a first blind recess extending from the first surface towards the second surface, and wherein the second recess defines a second blind recess extending from the second surface towards the first surface.

10. The proof mass element of claim 6, wherein disposing the evaporant over the first surface of the proof mass element comprises:
covering at least a portion of the first surface with a masking material; and
disposing the evaporant over the first surface of the proof mass element, wherein the masking material obscures the at least the portion of the first surface to cause the evaporant to define a first pattern over the first surface.

11. The proof mass element of claim 6, wherein disposing the evaporant over the second surface of the proof mass element comprises:
covering at least a portion of the second surface with a masking material; and
disposing the evaporant over the second surface of the proof mass element, wherein the masking material obscures the at least the portion of the second surface to cause the evaporant to define a second pattern over the second surface.

12. The proof mass element of claim 6, wherein the first recess comprises a first blind recess extending from the first surface towards the second surface, and wherein the first recess defines a first bottom surface electrically coupled to the first surface.

13. The proof mass element of claim 6, wherein the first recess comprises a second blind recess extending from the second surface towards the first surface, and wherein the second recess defines a second bottom surface electrically coupled to the second surface.

14. The proof mass element of claim 6, wherein the first recess and the second recess are disposed on a same half of the proof mass element.

15. The proof mass element of claim 6, wherein the first recess and the second recess are disposed on opposite halves of the proof mass element.

16. The proof mass element of claim 6, wherein the first bond and the second bond define a parallel gap weld between the first surface and the second surface.

17. A fixture for a proof mass element of an accelerometer, the fixture comprising:
a fixed portion; and
a movable portion defining an opening configured to retain the proof mass element, wherein the proof mass element defines:
a first surface;
a second surface parallel with the first surface; and
two or more recesses, wherein each recess of the two or more recesses extends from one of the first surface or the second surface towards the other of the first surface or the second surface,
wherein the fixture is configured to rotate the proof mass element via rotation of the movable portion relative to the fixed portion, and wherein when the proof mass element is retained within the opening, the fixture is configured to expose the first surface, the second surface, and the two or more recesses to allow for:
disposition of an evaporant over the first surface and the second surface; and
formation of a first bond between the first surface and an electrically conductive element within a first recess of the two or more recesses; and
formation of a second bond between the second surface and the electrically conductive element within a second recess of the two or more recesses, the second recess being different from the first recess.

18. The fixture of claim 17, wherein the movable portion is configured to rotate relative to the fixed portion to rotate the proof mass element up to 180 degrees about a reference plane orthogonal to a central axis of the proof mass element.

19. The fixture of claim 17, wherein the fixture is configured to be secured within one or more devices, and wherein the movable portion is configured to rotate relative to the fixed portion when the fixture is secured within the one or more devices.

20. The fixture of claim 19, wherein the one or more devices comprises one or more of:
an evaporator;
a wire bonding device; or
a sputtering machine.
